(19) United States
(12) Patent Application Publication
(10) Pub. No.: US 2022/0292560 A1
(43) Pub. Date: Sep. 15, 2022

(54) METHOD AND SYSTEM FOR ASSISTING A CUSTOMER IN REAL-TIME

(71) Applicant: TOSHIBA TEC KABUSHIKI KAISHA, Tokyo (JP)

(72) Inventors: Krishna Puthran, Bangalore (IN); Megha Sakrikar, Bangalore (IN)

(73) Assignee: TOSHIBA TEC KABUSHIKI KAISHA, Tokyo (JP)

(21) Appl. No.: 17/541,841

(22) Filed: Dec. 3, 2021

(30) Foreign Application Priority Data
Mar. 12, 2021 (IN) 202141010515

(51) Int. Cl. G06Q 30/06; G06Q 30/02

(52) U.S. Cl. CPC G06Q 30/0613; G06Q 30/0202

(57) ABSTRACT

A method and sale assistance system for assisting a customer in real-time when the customer is interested in a product is disclosed. The sale assistance system receives behavioural information associated with a customer present in a store based on a real-time data feed of the customer captured by monitoring devices located in the store. The data feed is captured while the customer is viewing and checking one or more products in the store and the behavioural information is predicated by a trained neural network by using the data feed. Based on the behavioural information, interest of the customer is identified for a product from the one or more product. Thereafter, an alert notification about the interest of the customer is provided to a store representative for the one or more products based on the identified interest of the customer while the customer is in the store.

### CROSS-REFERENCE TO RELATED APPLICATION

This application is based upon and claims the benefit of priority from Indian Patent Application No. 202141010515, filed Mar. 12, 2021, the entire contents of which are incorporated herein by reference.

### TECHNICAL FIELD

The present subject matter is related in general to sale systems and analysis systems and more particularly, but not exclusively, to methods and systems for assisting a customer in real-time.

### BACKGROUND

In today's modern and omnichannel environments, consumers are flooded with information about goods and services. Retailers that can connect with their customers by providing targeted information and offering value stand apart and have potential to create deep customer engagement. Although with emergence and advancements in technology, retailers target appropriate consumers and enable consumers to make better informed decisions about which products or services to consume. Yet not all consumer decisions rely on extensive information searches and detailed decision processes. Some decisions are spontaneous which may be quickly decided while shopping online or in stores.

Typically, any purchase provides the retailer a multitude of disparate information, including transactional data, consumer data, and the like. Retailers that can draw effective insights from such large data can make better predictions about consumer behavior, design more appealing offers, better target their customers, and develop tools that encourage consumers to make purchase decisions that favour their products.

Currently there exists many methodologies used by retailers for assisting customers while purchasing one or more products. However, experience of the customers is still affected due to non-availability of information in real-time. For instance, sometimes customers shopping in stores show enough interest in a product kept on aisles, but in the end do not buy it. In such cases, customers tend to hold the product in hand, turn it around, try to read the product details and spend a considerable amount of time analysing it. There may be multiple reasons for not buying it, such as not being happy with pricing, promotion, requiring some clarifications regarding branding, quality concerns, warranty issues, after sales service, and the like. Many a times, customers do not consult store associates to clarify their queries, but just decide not to buy the product. This may be a big problem for products which are newly launched, and customers are not much aware of brand and product itself. From the store perspective, they lose an opportunity to sell a product. If in case customer was a probable buyer and his/her concerns or questions were addressed, then such an opportunity could have got converted to sale. From a manufacturer's perspective, it is a lost opportunity to collect customer feedback, especially for newly launched products. Thus, assisting the customers in real-time for any liable product becomes very crucial from a sale perspective.

The information disclosed in this background of the disclosure section is only for enhancement of understanding of the general background of the present disclosure and should not be taken as an acknowledgement or any form of suggestion that this information forms the prior art already known to a person skilled in the art.

### SUMMARY

In an embodiment, the present disclosure may relate to a method for assisting a customer in real-time when the customer is interested in a product. The method comprises receiving behavioural information associated with a customer present in a store based on a real-time data feed of the customer captured by monitoring devices located in the store. The data feed is captured while the customer is viewing and checking one or more products in the store, and the behavioural information is predicated by a trained neural network by using the data feed. The method includes identifying interest of the customer for a product from the one or more product based on the behavioural information and providing alert notification about the interest of the customer to a store representative for the one or more products based on the identified interest of the customer while the customer is in the store.

In an embodiment, the present disclosure may relate to a sale assistance system for assisting a customer in real-time when the customer is interested in a product. The sale assistance system may comprise a processor and a memory communicatively coupled to the processor, where the memory stores processor executable instructions, which, on execution, may cause the sale assistance system to receive behavioural information associated with a customer present in a store based on a real-time data feed of the customer captured by monitoring devices located in the store. The data feed is captured while the customer is viewing and checking one or more products in the store, and the behavioural information is predicated by a trained neural network by using the data feed. The sale assistance system identifies an interest of the customer for a product from the one or more product based on the behavioural information and provides an alert notification about the interest of the customer to a store representative for the one or more products based on the identified interest of the customer while the customer is in the store.

In an embodiment, the present disclosure relates to a non-transitory computer readable medium including instructions stored thereon that when processed by at least one processor may cause a sale assistance system to receive behavioural information associated with a customer present in a store based on a real-time data feed of the customer captured by monitoring devices located in the store. The data feed is captured while the customer is viewing and checking one or more products in the store, and the behavioural information is predicated by a trained neural network by using the data feed. The instruction causes the processor to identify interest of the customer for a product from the one or more product based on the behavioural information and provides an alert notification about the interest of the customer to a store representative for the one or more products based on the identified interest of the customer while the customer is in the store

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE ACCOMPANYING DRAWINGS

The accompanying drawings, which are incorporated in and constitute a part of this disclosure, illustrate exemplary embodiments and, together with the description, serve to explain the disclosed principles. In the figures, the left-most digit(s) of a reference number identifies the figure in which the reference number first appears. The same numbers are used throughout the figures to reference like features and components. Some embodiments of system and/or methods in accordance with embodiments of the present subject matter are now described, by way of example only, and with reference to the accompanying figures, in which:

FIG. 1A-1B illustrate an exemplary environment for assisting a customer in real-time when the customer is interested in a product in accordance with some embodiments of the present disclosure;

FIG. 2 shows a detailed block diagram of a sale assistance system in accordance with some embodiments of the present disclosure;

FIG. 3A-3B show exemplary scenarios of a retail store for assisting a customer in real-time when the customer is interested in a product in accordance with some embodiments of the present disclosure;

FIG. 4 illustrates a flowchart showing a method for assisting a customer in real-time when the customer is interested in a product in accordance with some embodiments of present disclosure; and

FIG. 5 illustrates a block diagram of an exemplary computer system for implementing embodiments consistent with the present disclosure.

It should be appreciated by those skilled in the art that any block diagrams herein represent conceptual views of illustrative systems embodying the principles of the present subject matter. Similarly, it will be appreciated that any flow charts, flow diagrams, state transition diagrams, pseudo code, and the like represent various processes which may be substantially represented in computer readable medium and executed by a computer or processor, whether or not such computer or processor is explicitly shown.

### DETAILED DESCRIPTION

In the present document, the word “exemplary” is used herein to mean “serving as an example, instance, or illustration.” Any embodiment or implementation of the present subject matter described herein as “exemplary” is not necessarily to be construed as preferred or advantageous over other embodiments.

While the disclosure is susceptible to various modifications and alternative forms, a specific embodiment thereof has been shown by way of example in the drawings and will be described in detail below. It should be understood, however, that it is not intended to limit the disclosure to the particular forms disclosed, but on the contrary, the disclosure is to cover all modifications, equivalents, and alternatives falling within the spirit and the scope of the disclosure.

The terms “comprises,” “comprising,” or any other variations thereof, are intended to cover a non-exclusive inclusion, such that a setup, device, or method that comprises a list of components or steps does not include only those components or steps but may include other components or steps not expressly listed or inherent to such setup or device or method. In other words, one or more elements in a system or apparatus proceeded by “comprises . . . a” does not, without more constraints, preclude the existence of other elements or additional elements in the system or method.

In the following detailed description of the embodiments of the disclosure, reference is made to the accompanying drawings that form a part hereof, and in which are shown by way of illustration specific embodiments in which the disclosure may be practiced. These embodiments are described in sufficient detail to enable those skilled in the art to practice the disclosure, and it is to be understood that other embodiments may be utilized and that changes may be made without departing from the scope of the present disclosure. The following description is, therefore, not to be taken in a limiting sense.

Embodiments of the present disclosure may relate to a method and sale assistance system for assisting a customer in real-time when the customer is interested in a product. Currently there exists many methodologies used by retailers for assisting customers while purchasing one or more products. However, experience of the customers is still affected due to non-availability of information in real-time. For instance, sometimes customers shopping in stores show enough interest in a product, but in the end may end up not buying the product. In such cases, customers tend to hold the product in hand, turn it around, try to read the product details, and spend a considerable amount of time analysing it. There may be multiple reasons for not buying it, such as not being happy with pricing, promotion, requiring some clarifications regarding branding, quality concerns, warranty issues, after sales service, and the like. Many a times, customers do not consult store associates to clarify their queries, but just decide not to buy the product. This may be a big problem for products which are newly launched, and customers are not much aware of brand and product itself.

The present disclosure resolves this problem by identifying interest of the customer for a product based on behavioural information. The behavioural information is associated with the customer present in a store based on a real-time data feed of the customer captured by monitoring devices located in the store. The data feed is captured while the customer is viewing and checking one or more products in the store. Thereafter, an alert notification about the interest of the customer is provided to a store representative for one or more products based on the identified interest of the customer while the customer is in the store. Therefore, the present disclosure assists the customer in real-time while the customer is in the store. Thus, the present disclosure provides an opportunity to understand concerns of the customers for any product in real-time.

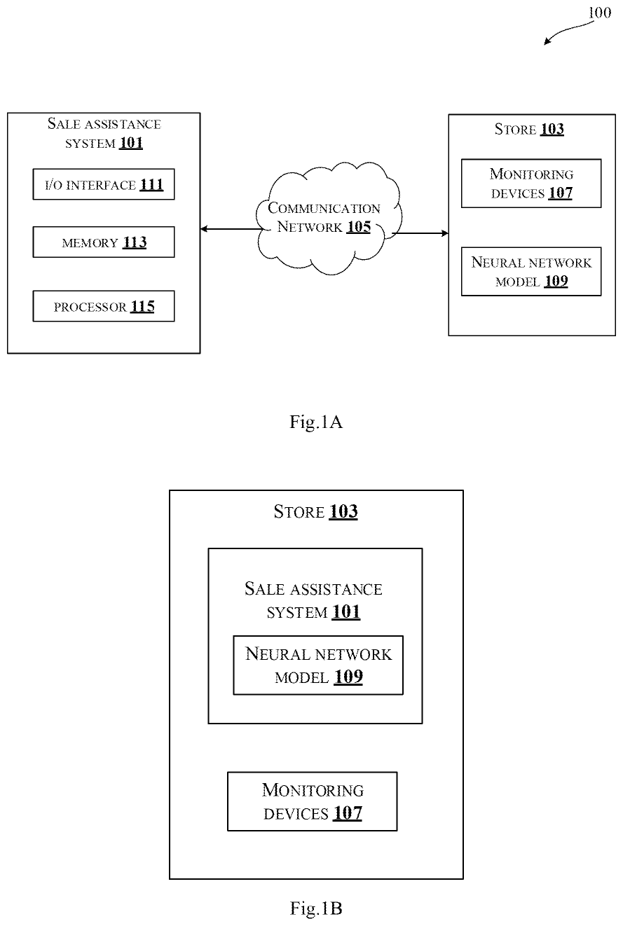

FIG. 1A illustrate an exemplary environment for assisting a customer in real-time when the customer is interested in a product in accordance with some embodiments of the present disclosure.

As shown in FIG. 1A, an environment 100 includes a sale assistance system 101 connected to a store 103 through a communication network 105. Particularly, the sale assistance system 101 may be connected to a server of the store 103 (not shown in FIG. 1A explicitly). In an embodiment, the sale assistance system 101 may be present within the server of the store 103, as shown in FIG. 1B. In an embodiment, the communication network 105 may include, but is not limited to, a direct interconnection, a Peer-to-Peer (P2P) network, Local Area Network (LAN), Wide Area Network (WAN), wireless network (for example, using Wireless Application Protocol), Internet, Wi-Fi, and the like.

In an embodiment, the store 103 may be defined as a business place for retail sale of products and services. The store 103 includes monitoring devices 107 located at one or more locations near one or more products and at one or more positions of the store 103. The monitoring devices 107 may include video surveillance cameras. Further, the store 103 may include a neural network model 109 for predicting behavioural information associated with a customer.

The sale assistance system 101 may be used for assisting a customer in real-time. Particularly, when the customer is interested in a product. The sale assistance system 101 may include, but is not limited to, a laptop, a desktop computer, a notebook, a smartphone, a tablet, a server, and any other computing devices. A person skilled in the art would understand that any other devices, not mentioned explicitly, may also be used as the sale assistance system 101 in the present disclosure.

Further, the sale assistance system 101 may include an input/output (I/O) interface 111, a memory 113 and a processor 115. The I/O interface 111 may be configured to receive behavioural information associated with a customer present in the store 103 based on a real-time data feed of the customer captured by the monitoring devices 107. The behavioural information from the I/O interface 111 may be stored in the memory 113. The memory 113 may be communicatively coupled to the processor 115 of the sale assistance system 101. The memory 113 may also store processor instructions which may cause the processor 115 to execute the instructions for assisting a customer in real-time when the customer is interested in a product.

At any instant, when a customer is present in the store 103 and viewing and checking one or more products, the monitoring devices 107 may continuously capture a data feed associated with the customer. Simultaneously, the data feed from the monitoring devices 107 may be provided to the neural network model 109 for predicting the behavioural information associated with the customer. The neural network model 109 may be trained previously using training data associated with customer in the store 103. In an embodiment, the neural network model 109 may be present in the sale assistance system 101. In an embodiment, any existing behavioural analysis neural network models may be used for predicting the behavioural information of the customer. The neural network model 109 may be, for instance, a Convolution Neural Network (CNN) model.

The behavioural information may indicate behavioural of the customer while viewing one or more products in the store 103. For instance, a customer in the store 103 holding a product for more than ten minutes and continuously reading details about the product and keeping the product back in stack in the store 103.

Further, based on the behavioural information, the sale assistance system 101 identifies an interest of the customer for the product. For instance, considering the above example, the sale assistance system 101 may indicate that the customer is interested in buying the product but may have some confusion and queries on the product. The sale assistance system 101 may store the interest of the customer for the one or more products. Consequently, the sale assistance system 101 may provide an alert notification about the interest of the customer to a store representative for the one or more products based on the identified interest of the customer while the customer is in the store 103. In an embodiment, the store representative is one of: a support representative associated with one or more sections of the store 103 for assisting the customer, or a representative at a checkout counter. The alert notification may be provided upon identifying the customer at a specific location of the store 103 using the monitoring devices 107. For instance, the specific location may be one or more sections in the store 103 used for displaying the one or more products and the checkout counter of the store 103. In one example, the customer is identified at the checkout counter. In this example, the sale assistance system 101 may include checking an order list of the customer using the monitoring devices 107 located near the checkout counter.

Further, the sale assistance system 101 may check a presence of one of the products in the order list for which the interest of the customer is identified. Finally, an alert notification is transmitted to a representative at a checkout counter with relevant information about the customer and the interest associated with the product when the product is not in the order list. Thus, the store representative with the relevant information on the product communicates with the customer about the product. The communication may include for instance, providing one or more discounts in case of pricing concern of the customer and providing response for queries on the product and seeking feedback of the customer on the product.

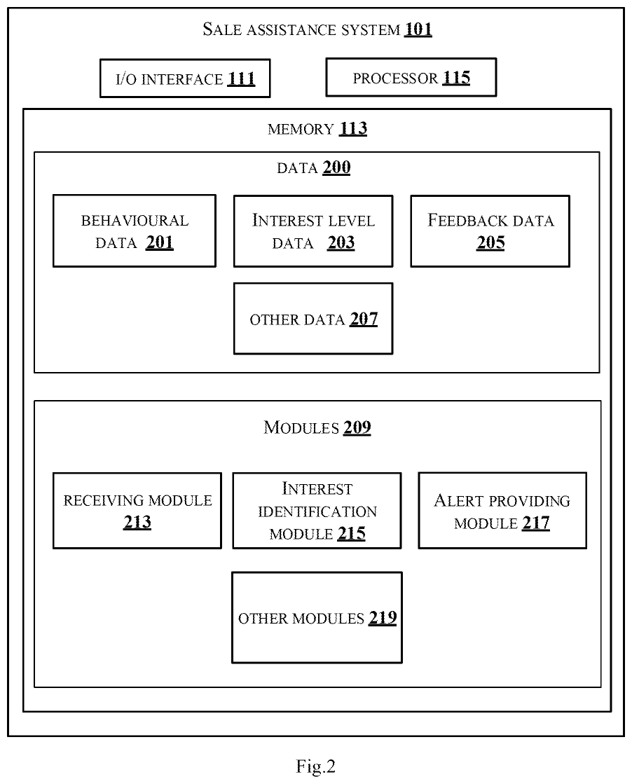

FIG. 2 shows a detailed block diagram of a sale assistance system in accordance with some embodiments of the present disclosure.

The sale assistance system 101 may include data 200 and one or more modules 209 which are described herein in detail. In an embodiment, data 200 may be stored within the memory 113. The data 200 may include, for example, behavioural data 201, interest level data 203, feedback data 205, and other data 207.

The behavioural data 201 may include behavioural details associated with the customer present in the store 103. The behavioural data 201 may be received from the store 103. The behavioural information is predicated by the neural network model 109 by using the data feed captured by the monitoring devices 107 located in the store 103.

The interest level data 203 may include information about the interest of the customer while the customer is viewing and checking one or more products in the store 103. For instance, the information may include whether the customer is interested in the product or not.

The feedback data 205 may include feedback of the customer on the product received while communicating with the customer about the product.

The other data 207 may store data, including temporary data and temporary files, generated by modules 209 for performing the various functions of the sale assistance system 101.

In an embodiment, the data 200 in the memory 113 are processed by the one or more modules 209 present within the memory 113 of the sale assistance system 101. In an embodiment, the one or more modules 209 may be implemented as dedicated units. As used herein, the term module refers to an application specific integrated circuit (ASIC), an electronic circuit, a field-programmable gate arrays (FPGA), Programmable System-on-Chip (PSoC), a combinational logic circuit, and/or other suitable components that provide the described functionality. In some implementations, the one or more modules 209 may be communicatively coupled to the processor 115 for performing one or more functions of the sale assistance system 101. The said modules 209 when configured with the functionality defined in the present disclosure will result in a novel hardware.

In one implementation, the one or more modules 209 may include, but are not limited to, a receiving module 213, an interest identification module 215, and an alert providing module 217. The one or more modules 209 may also include other modules 219 to perform various miscellaneous functionalities of the sale assistance system 101. In an embodiment, the other modules 219 may include a training module for training the neural network model 109 using the training data associated with customers in the store 103.

The receiving module 213 may receive behavioural information associated with the customer present in the store 103 based on the real-time data feed of the customer captured by the monitoring devices 107 located in the store 103. The data feed is captured while the customer is viewing and checking one or more products in the store 103. The behavioural information is received through the server of the store 103. Further, the receiving module 213 may receive the feedback of the customer on the one or more products.

The interest identification module 215 may identify the interest of the customer for the product from the one or more product based on the behavioural information. For instance, if the customer seems interested, confused, or not interested to buy the product. For instance, consider, if the behavioural information indicates that a customer is viewing the product for five to ten minutes and gestures of the customer identify the customer as confused, the interest identification module 215 may identify that the customer is interested in buying the product. However, the customer may have a few queries or concerns on the product.

The alert providing module 217 may provide the alert notification about the interest of the customer to the store representative for the one or more products based on the identified interest of the customer while the customer is in the store 103. In an embodiment, the store representative is one of: the support representative associated with the one or more sections of the store 103 for assisting the customer, or the representative at a checkout counter. The alert providing module 217 may provide the alert notification on identifying the customer at the specific location of the store 103. For instance, the specific location may be the one or more sections in the store 103 used for displaying the one or more products and the checkout counter of the store 103.

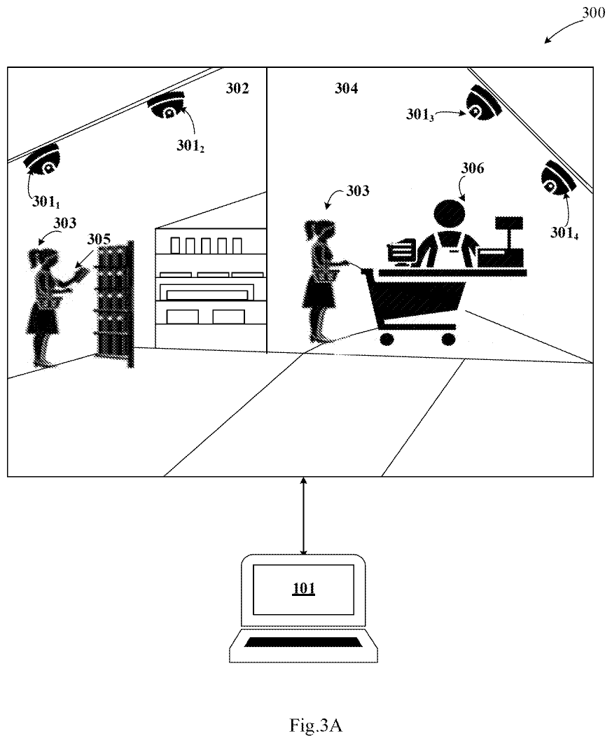

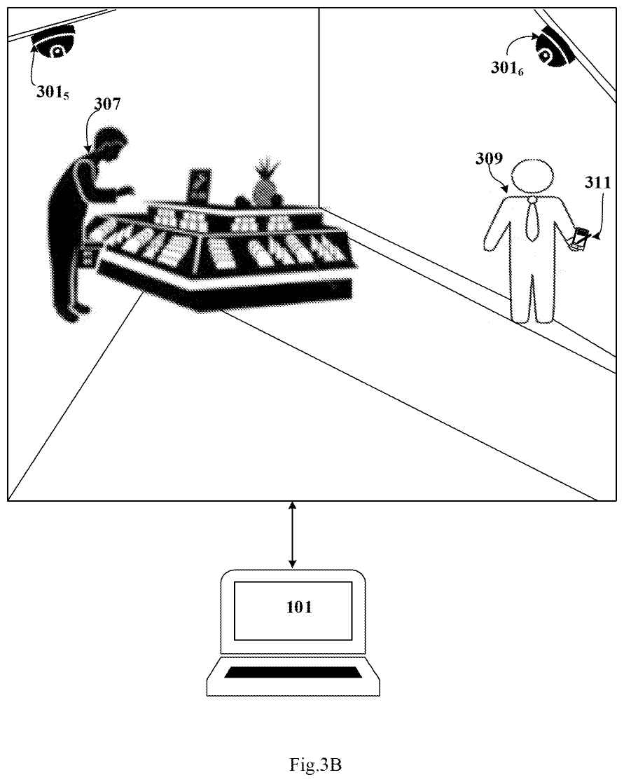

FIG. 3A-3B show exemplary scenarios of a retail store for assisting a customer in real-time when the customer is interested in a product in accordance with some embodiments of the present disclosure.

FIG. 3A shows an exemplary scenario of a retail store 300. In current context, two sections of the retail store 300 is illustrated. The retail store 300 includes monitoring devices such as, surveillance camera 301₁ and a surveillance camera 301₂ in a first section 302. Further, the retail store 300 includes a surveillance camera 301₃ and surveillance camera 301₄ in a second section 304. The first section 302 includes a customer 303 viewing and checking a product 305.

Thus, in this scenario, the surveillance camera 301₁ and the surveillance camera 301₂ may capture real-time data feed while the customer 303 is viewing the product 305. The data feed is provided to the neural network model 109 for predicting the behavioural information of the customer 303. The behavioural information may be used further to identify the interest of the customer 303 for the product. For instance, in the current context, assume that the behavioural information for the customer 303 indicates that the customer 303 is confused about the product 305. The interest of the customer 303 for the product 305 is stored for further analysis. Further, the customer 303 is monitored in the retail store 300 at a specific location. For instance, the customer 303 is monitored and identified at the second section 304 of the retail store 300, which is a checkout counter. In such condition, the surveillance camera 301₃ and the surveillance camera 301₄ may check a presence of the product 305 in an order list of the customer 303. Consider, the product 305 is not identified in the order list of the customer 303. In such case, the sale assistance system 101 may provide an alert notification by transmitting to a checkout representative 306 present at the checkout counter with relevant information about the customer 303 and the interest associated with the product 305. Thus, the checkout representative 306 with the relevant information on the product 305 may communicate with the customer 303 about the product. The communication may include, for instance, providing one or more discounts in case of pricing concern of the customer 303 and providing response for queries on the product 305 and seeking feedback of the customer 303 on the product 305.

In another scenario, as shown in FIG. 3B, consider another part of the retail store 300, where a customer 307 is being monitored using a surveillance camera 301₅. Similar to above scenario in FIG. 3A, the behavioural information associated with the customer 307 is received by the sale assistance system 101. The behavioural information of the customer 307 is used for identifying the interest of the customer 307. For instance, considering the customer 307 is very much interested in a product, but may have queries on the product. In such condition, the sale assistance system 101 may provide the alert notification to a support representative 309 located nearby the customer 307 for assisting the customer 307. The alert notification may be received on a mobile device 311 of the support representative.

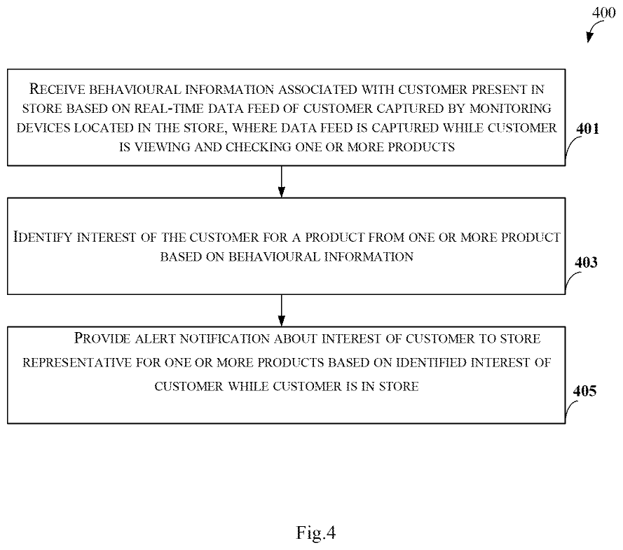

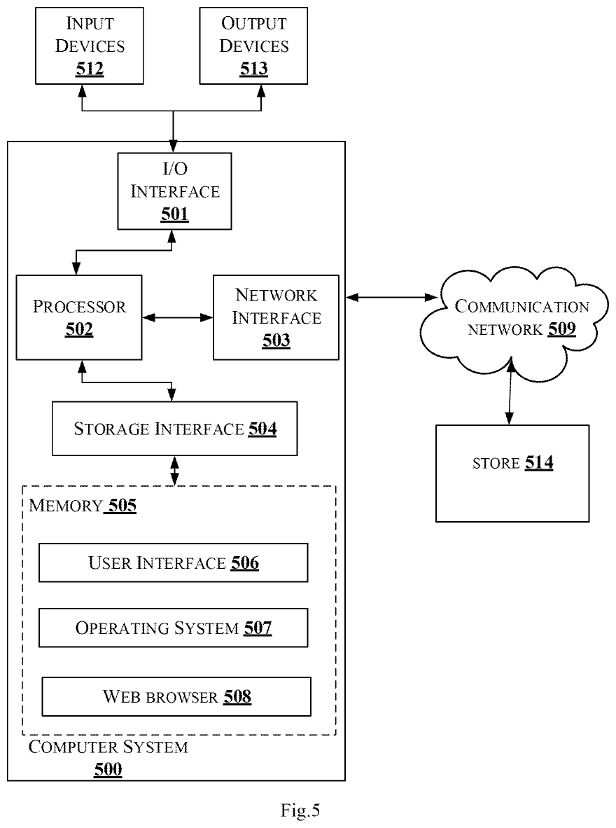

FIG. 4 illustrates a flowchart showing a method for assisting a customer in real-time when the customer is interested in a product in accordance with some embodiments of present disclosure.

As illustrated in FIG. 4, the method 400 includes one or more blocks for assisting a customer in real-time when the customer is interested. The method 400 may be described in the general context of computer executable instructions. Generally, computer executable instructions can include routines, programs, objects, components, data structures, procedures, modules, and functions, which perform particular functions or implement particular abstract data types.

The order in which the method 400 is described is not intended to be construed as a limitation, and any number of the described method blocks can be combined in any order to implement the method. Additionally, individual blocks may be deleted from the methods without departing from the scope of the subject matter described herein. Furthermore, the method can be implemented in any suitable hardware, software, firmware, or combination thereof.

At block 401, the behavioural information associated with the customer present in the store 103 is received by the receiving module 213 based on a real-time data feed of the customer captured by the monitoring devices 107 located in the store 103. The data feed is captured while the customer is viewing and checking one or more products in the store 103. The behavioural information is predicated by the trained neural network model 109 by using the data feed.

At block 403, the interest of the customer is identified by the interest identification module 215 for the product from the one or more product based on the behavioural information.

At block 405, the alert notification is provided by the alert providing module 217 about the interest of the customer to the store representative for the one or more products based on the identified interest of the customer while the customer is in the store 103. The alert notification may be provided upon identifying the customer at the specific location of the store 103 using the monitoring devices 107. For instance, the specific location may be the one or more sections in the store 103 used for displaying the one or more products and the checkout counter of the store 103. In one example, the customer is identified at the checkout counter. In this example, the sale assistance system 101 may include checking an order list of the customer using the monitoring devices 107 located near the checkout counter.

### Computing System

FIG. 5 illustrates a block diagram of an exemplary computer system 500 for implementing embodiments consistent with the present disclosure. In an embodiment, the computer system 500 may be used to implement the sale assistance system 101. The computer system 500 may include a central processing unit (“CPU” or “processor”) 502. The processor 502 may include at least one data processor for assisting a customer in real-time when the customer is interested in a product. The processor 502 may include specialized processing units such as integrated system (bus) controllers, memory management control units, floating point units, graphics processing units, digital signal processing units, etc.

The processor 502 may be disposed in communication with one or more I/O devices (not shown) via I/O interface 501. The I/O interface 501 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using the I/O interface 501, the computer system 500 may communicate with one or more I/O devices such as input devices 512 and output devices 513. For example, the input devices 512 may be an antenna, a keyboard, a mouse, a joystick, a (infrared) remote control, a camera, a card reader, a fax machine, a dongle, a biometric reader, a microphone, a touch screen, a touchpad, a trackball, a stylus, a scanner, a storage device, a transceiver, a video device/source, etc. The output devices 613 may be a printer, a fax machine, a video display (e.g., Cathode Ray Tube (CRT), Liquid Crystal Display (LCD), Light-Emitting Diode (LED), plasma, Plasma Display Panel (PDP), Organic Light-Emitting Diode display (OLED) or the like), audio speaker, etc.

In some embodiments, the computer system 500 consists of the sale assistance system 101. The processor 502 may be disposed in communication with the communication network 509 via a network interface 503. The network interface 503 may communicate with the communication network 509. The network interface 503 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. The communication network 509 may include, without limitation, a direct interconnection, LAN, WAN, wireless network (e.g., using Wireless Application Protocol), the Internet, etc. Using the network interface 503 and the communication network 509, the computer system 500 may communicate with store 514. The network interface 503 may employ connection protocols include, but not limited to, direct connect, Ethernet (e.g., twisted pair 10/100/1000 Base T), TCP/IP, token ring, IEEE 802.11a/b/g/n/x, etc.

The communication network 509 includes, but is not limited to, a direct interconnection, an e-commerce network, a P2P network, LAN, WAN, wireless network (e.g., using Wireless Application Protocol), the Internet, Wi-Fi, and such. The first network and the second network may either be a dedicated network or a shared network, which represents an association of the different types of networks that use a variety of protocols, for example, Hypertext Transfer Protocol (HTTP), TCP/IP, Wireless Application Protocol (WAP), etc., to communicate with each other. Further, the first network and the second network may include a variety of network devices, including routers, bridges, servers, computing devices, storage devices, etc.

In some embodiments, the processor 502 may be disposed in communication with a memory 505 (e.g., Random Access Memory (RAM), Read-Only Memory (ROM), etc. not shown in FIG. 4) via a storage interface 504. The storage interface 504 may connect to memory 505 including, without limitation, memory drives, removable disc drives, etc., employing connection protocols such as serial advanced technology attachment (SATA), Integrated Drive Electronics (IDE), IEEE-1394, Universal Serial Bus (USB), fiber channel, Small Computer Systems Interface (SCSI), etc. The memory drives may further include a drum, magnetic disc drive, magneto-optical drive, optical drive, Redundant Array of Independent Discs (RAID), solid-state memory devices, solid-state drives, etc.

The memory 505 may store a collection of program or database components, including, without limitation, user interface 506, an operating system 507 etc. In some embodiments, computer system 500 may store user/application data, such as the data, variables, records, etc., as described in this disclosure. Such databases may be implemented as fault-tolerant, relational, scalable, secure databases such as Oracle or Sybase.

The operating system 507 may facilitate resource management and operation of the computer system 500. Examples of operating systems include, without limitation, APPLE MACINTOSH® OS X, UNIX®, UNIX-like system distributions (e.g., BERKELEY SOFTWARE DISTRIBUTION™ (BSD), FREEBSD™, NETBSD™, OPENBSD™, etc.), LINUX DISTRIBUTIONS™ (e.g., RED HAT™, UBUNTU™, KUBUNTU™, etc.), IBM™ OS/2, MICROSOFT™ WINDOWS™ (XP™, VISTA™/7/8, 10 etc.), APPLE® IOS™, GOOGLE® ANDROID™, BLACKBERRY® OS, or the like.

In some embodiments, the computer system 500 may implement a web browser 508 stored program component. The web browser 508 may be a hypertext viewing application, for example MICROSOFT® INTERNET EXPLORER™, GOOGLE® CHROME™, MOZILLA® FIREFOX™, APPLE® SAFARI™, etc. Secure web browsing may be provided using Secure Hypertext Transport Protocol (HTTPS), Secure Sockets Layer (SSL), Transport Layer Security (TLS), etc. Web browsers 508 may utilize facilities such as AJAX™, DHTML™, ADOBE® FLASH™, JAVASCRIPT™, JAVA™, Application Programming Interfaces (APIs), etc. In some embodiments, the computer system 500 may implement a mail server stored program component. The mail server may be an Internet mail server such as Microsoft Exchange, or the like. The mail server may utilize facilities such as ASP™, ACTIVEX™, ANSI™ C++/C #, MICROSOFT®, NET™, CGI SCRIPTS™, JAVA™, JAVASCRIPT™, PERL™, PHP™, PYTHON™, WEBOBJECTS™, etc. The mail server may utilize communication protocols such as Internet Message Access Protocol (IMAP), Messaging Application Programming Interface (MAPI), MICROSOFT® exchange, Post Office Protocol (POP), Simple Mail Transfer Protocol (SMTP), or the like. In some embodiments, the computer system 500 may implement a mail client stored program component. The mail client may be a mail viewing application, such as APPLE® MAIL™, MICROSOFT® ENTOURAGE™, MICROSOFT® OUTLOOK™, MOZILLA® THUNDERBIRD™, etc.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include RAM, ROM, volatile memory, non-volatile memory, hard drives, CD ROMs, DVDs, flash drives, disks, and any other known physical storage media.

An embodiment of the present disclosure provides a sales opportunity for high value items is not lost.

An embodiment of the present disclosure provides an opportunity to understand customer concerns.

An embodiment of the present disclosure provides an opportunity for the store for an upsell.

An embodiment of the present disclosure enables collection of valuable information for the product manufactures regarding the product.

The disclosed method and system overcome technical problem of assisting the customers in real-time by identifying interest of the customer for a product based on behavioural information, which is associated with the customer present in a store based on a real-time data feed of the customer captured by monitoring devices located in the store. The data feed is captured while the customer is viewing and checking one or more products in the store. Thereafter, an alert notification about the interest of the customer is provided to a store representative for one or more products based on the identified interest of the customer while the customer is in the store. Therefore, the present disclosure assists the customer in real-time while the customer is in the store. Thus, providing an opportunity to understand concerns of the customers for any product in real-time.

Currently, there exists many methodologies used by retailers for assisting customers while purchasing one or more products. However, experience of the customers is still affected due to non-availability of information in real-time. For instance, sometimes customers shopping in stores show enough interest in a product, but in the end may end up not buying the product. In such cases, customers tend to hold the product in hand, turn it around, try to read the product details and spend a considerable amount of time analysing it. There may be multiple reasons for not buying it, such as not being happy with pricing, promotion, requiring some clarifications regarding branding, quality concerns, warranty issues, after sales service, and the like. Many a times, customers do not consult store associates to clarify their queries, but just decide not to buy the product. This may be a big problem for products which are newly launched, and customers are not much aware of brand and product itself.

In light of the above-mentioned advantages and the technical advancements provided by the disclosed method and system, the steps as discussed above are not routine, conventional, or well understood in the art, as the steps enable the following solutions to the existing problems in conventional technologies. Further, the steps clearly bring an improvement in the functioning of the system itself as the steps provide a technical solution to a technical problem.

The described operations may be implemented as a method, system, or article of manufacture using standard programming and/or engineering techniques to produce software, firmware, hardware, or any combination thereof. The described operations may be implemented as code maintained in a “non-transitory computer readable medium,” where a processor may read and execute the code from the computer readable medium. The processor is at least one of a microprocessor or a processor capable of processing and executing the queries. A non-transitory computer readable medium may include media such as magnetic storage medium (e.g., hard disk drives, floppy disks, tape, etc.), optical storage (CD-ROMs, DVDs, optical disks, etc.), volatile and non-volatile memory devices (e.g., EEPROMs, ROMs, PROMs, RAMs, DRAMs, SRAMs, Flash Memory, firmware, programmable logic, etc.), etc. Further, non-transitory computer-readable media include all computer-readable media except for a transitory. The code implementing the described operations may further be implemented in hardware logic (e.g., an integrated circuit chip, Programmable Gate Array (PGA), ASIC, etc.).

Still further, the code implementing the described operations may be implemented in “transmission signals,” where transmission signals may propagate through space or through a transmission media, such as, an optical fiber, copper wire, etc. The transmission signals in which the code or logic is encoded may further include a wireless signal, satellite transmission, radio waves, infrared signals, Bluetooth, etc. The transmission signals in which the code or logic is encoded is capable of being transmitted by a transmitting station and received by a receiving station, where the code or logic encoded in the transmission signal may be decoded and stored in hardware or a non-transitory computer readable medium at the receiving and transmitting stations or devices. An “article of manufacture” includes non-transitory computer readable medium, hardware logic, and/or transmission signals in which code may be implemented. A device in which the code implementing the described embodiments of operations is encoded may include a computer readable medium or hardware logic. Of course, those skilled in the art will recognize that many modifications may be made to this configuration without departing from the scope of the present disclosure, and that the article of manufacture may include suitable information bearing medium known in the art.

The terms “an embodiment,” “embodiment,” “embodiments,” “the embodiment,” “the embodiments,” “one or more embodiments,” “some embodiments,” and “one embodiment” mean “one or more (but not all) embodiments of the present disclosure” unless expressly specified otherwise.

The terms “including,” “comprising,” “having,” and variations thereof mean “including but not limited to,” unless expressly specified otherwise.

The enumerated listing of items does not imply that any or all of the items are mutually exclusive, unless expressly specified otherwise.

The terms “a,” “an,” and “the” mean “one or more,” unless expressly specified otherwise.

A description of an embodiment with several components in communication with each other does not imply that all such components are required. On the contrary, a variety of optional components are described to illustrate the wide variety of possible embodiments of the present disclosure.

When a single device or article is described herein, it will be readily apparent that more than one device/article (whether or not they cooperate) may be used in place of a single device/article. Similarly, where more than one device or article is described herein (whether or not they cooperate), it will be readily apparent that a single device/article may be used in place of the more than one device or article or a different number of devices/articles may be used instead of the shown number of devices or programs. The functionality and/or the features of a device may be alternatively embodied by one or more other devices which are not explicitly described as having such functionality/features. Thus, other embodiments of the present disclosure need not include the device itself.

The illustrated operations of FIG. 5 show certain events occurring in a certain order. In alternative embodiments, certain operations may be performed in a different order, modified, or removed. Moreover, steps may be added to the above-described logic and still conform to the described embodiments. Further, operations described herein may occur sequentially or certain operations may be processed in parallel. Additionally, operations may be performed by a single processing unit or by distributed processing units.

Finally, the language used in the specification has been principally selected for readability and instructional purposes, and it may not have been selected to delineate or circumscribe the subject matter of the present disclosure. It is therefore intended that the scope of the present disclosure be limited not by this detailed description, but rather by any claims that issue on an application based here on. Accordingly, the description of the embodiments of the present disclosure is intended to be illustrative, but not limiting, of the scope of the present disclosure, which is set forth in the following claims.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A method of assisting a customer in real-time when the customer is interested in a product, the method comprising:
receiving, by a sale assistance system, behavioural information associated with a customer present in a store based on a real-time data feed of the customer captured by monitoring devices located in the store, wherein the data feed is captured while the customer is viewing and checking one or more products in the store, and wherein the behavioural information is predicated by a trained neural network by using the data feed;
identifying, by the sale assistance system, an interest of the customer for a target product from the one or more products based on the behavioural information; and
providing, by the sale assistance system, an alert notification about the interest to a store representative while the customer is in the store.

2. The method of claim 1, wherein the monitoring devices comprise video surveillance cameras.

3. The method of claim 1, wherein the store representative is one of:
a support representative associated with one or more sections of the store for assisting the customer, or
a representative at a checkout counter.

4. The method of claim 1, wherein providing the alert notification further comprises:
storing the interest; and
identifying the customer at a target location of the store using one or more target monitoring devices located in the target location in order to assist the customer.

5. The method of claim 4, wherein the target location comprises one or more sections in the store used for displaying the one or more products and a checkout counter of the store.

6. The method of claim 5, further comprising:
identifying the customer at the checkout counter;
checking an order list of the customer, the order list comprising one or more order list products;
checking presence of the target product within the one or more order list products; and
providing a representative alert notification to a store representative with relevant information about the customer and the interest when the target product is not within the one or more order list products.

7. The method of claim 6, wherein the store representative communicates with the customer about the target product.

8. The method of claim 7, wherein the communication comprises providing one or more discounts in case of pricing concern of the customer and providing response for queries on the target product.

9. The method of claim 7, wherein the communication comprises seeking feedback of the customer on the target product.

10. The method of claim 1, further comprising identifying, by the sale assistance system, the target product using the monitoring devices, wherein the monitoring devices are associated with a location of each of the one or more products.

11. A sale assistance system for assisting a customer in real-time when the customer is interested in a target product, the sale assistance system comprising:
a processor; and
a memory communicatively coupled to the processor, wherein the memory stores processor instructions, which, on execution, cause the processor to:
receive behavioural information associated with a customer present in a store based on a real-time data feed of the customer captured by monitoring devices located in the store, wherein the data feed is captured while the customer is viewing and checking one or more products in the store, and wherein the behavioural information is predicated by a trained neural network by using the data feed,
identify an interest of the customer for a target product from the one or more products based on the behavioural information, and
provide an alert notification about the interest to a store representative while the customer is in the store.

12. The sale assistance system of claim 11, wherein the monitoring devices comprise video surveillance cameras.

13. The sale assistance system of claim 11, wherein the store representative is one of:
a support representative associated with one or more sections of the store for assisting the customer, or
a representative at a checkout counter.

14. The sale assistance system of claim 11, wherein the processor instructions, on execution, cause the processor to provide the alert notification by:
storing the interest; and
identifying the customer at a target location of the store using one or more target monitoring devices located in the target location in order to assist the customer.

15. The sale assistance system of claim 14, wherein the target location comprises one or more sections in the store and a checkout counter of the store.

16. The sale assistance system of claim 15, wherein the processor instructions, on execution, cause the processor to:
identify the customer at the checkout counter;
check an order list of the customer, the order list comprising one or more order list products;
check presence of one of the target product within the one or more order list products; and
provide a representative alert notification to a store representative with relevant information about the customer and the interest when the target product is not within the one or more order list products.

17. The sale assistance system of claim 16, wherein the store representative communicates with the customer about the target product.

18. The sale assistance system of claim 17 wherein the communication comprises providing one or more discounts in case of pricing concern of the customer and providing response for queries on the target product.

19. The sale assistance system of claim 17, wherein the communication comprises seeking feedback of the customer on the target product.

20. The sale assistance system of claim 11, wherein the processor instructions, on execution, cause the processor to identify the target product using the monitoring devices, wherein the monitoring devices are associated with a location of each of the one or more products.

21. A non-transitory computer readable medium including instructions stored thereon that when processed by at least one processor cause a sale assistance system to perform operations comprising:
receiving behavioural information associated with a customer present in a store based on a real-time data feed of the customer captured by monitoring devices located in the store, wherein the data feed is captured while the customer is viewing and checking one or more products in the store, and wherein the behavioural information is predicated by a trained neural network by using the data feed;
identifying an interest of the customer for a target product from the one or more products based on the behavioural information; and
providing an alert notification about the interest to a store representative while the customer is in the store.

22. The non-transitory computer readable medium of claim 21, wherein the monitoring devices comprise video surveillance cameras.

23. The non-transitory computer readable medium of claim 21, wherein the store representative is one of:
a support representative associated with one or more sections of the store for assisting the customer, or
a representative at a checkout counter.

24. The non-transitory computer readable medium of claim 21, wherein providing the alert notification further comprises:
storing the interest; and
identifying the customer at a target location of the store using one or more target monitoring devices located in the target location in order to assist the customer.

25. The non-transitory computer readable medium of claim 24, wherein the target location comprises one or more sections in the store used for displaying the one or more products and a checkout counter of the store.

26. The non-transitory computer readable medium of claim 25, wherein the operations further comprise:
identifying the customer at the checkout counter;
checking an order list of the customer, the order list comprising one or more order list products;
checking presence of the target product within the one or more order list products; and
providing a representative alert notification to a store representative with relevant information about the customer and the interest when the target product is not within the one or more order list products.

27. The non-transitory computer readable medium of claim 26, wherein the store representative communicates with the customer about the target product.

28. The non-transitory computer readable medium of claim 27, wherein the communication comprises providing one or more discounts in case of pricing concern of the customer and providing response for queries on the target product.

29. The non-transitory computer readable medium of claim 27, wherein the communication comprises seeking feedback of the customer on the target product.

30. The non-transitory computer readable medium of claim 21, wherein the operations further comprising identifying the target product using the monitoring devices, the monitoring devices associated with a location of each of the one or more products.
